(19) United States
(12) Patent Application Publication
(10) Pub. No.: US 2014/0072214 A1
(43) Pub. Date: Mar. 13, 2014

(54) IMAGE PROCESSING SYSTEM

(71) Applicant: TOKYO INSTITUTE OF TECHNOLOGY, Meguro-ku, Tokyo (JP)

(72) Inventors: Masayuki Tanaka, Meguro-Ku (JP); Masatoshi Okutomi, Meguro-Ku (JP); Yusuke Monno, Meguro-Ku (JP)

(21) Appl. No.: 14/117,018

(22) PCT Filed: Apr. 27, 2012
(86) PCT No.: PCT/JP2012/002909

§ 371 Date: Nov. 11, 2013

(30) Foreign Application Priority Data
May 11, 2011 (JP) 2011-106717

(51) Int. Cl. G06T 3/40

(52) U.S. Cl. CPC G06T 3/4007
USPC 382/165

(57) ABSTRACT

An image processing system includes a reception unit, a derivative calculation unit, a reference image creation unit, and an interpolated image creation unit. The reception unit receives an original image signal formed by a plurality of pixel signals in which any of first through m^{th} (m being an integer three or greater) color signal components is lacking. The derivative calculation unit calculates a derivative for the pixel signals using two pixels sandwiching a pixel corresponding to the pixel signals. The reference image creation unit creates a primary reference image using the first color signal component, which has the largest number of elements among the pixel signals of the original image signal. The interpolated image creation unit creates an interpolated image by interpolating all of the color signal components using the primary reference image. At least one of the primary reference image and the interpolated image is created using the derivative. As a result, the occurrence of false colors is suppressed while using a multiband color filter.

### CROSS REFERENCE TO RELATED APPLICATION

This application claims priority to and the benefit of Japanese Patent Application No. 2011-106717 filed on May 11, 2011, the entire contents of which are incorporated herein by reference.

### TECHNICAL FIELD

The present invention relates to an image processing system for color interpolation of an original image signal generated by imaging with an image sensor or the like provided with a multiband color filter.

### BACKGROUND ART

In recent years, multispectral imaging has been attracting attention for the purpose of faithful color reproduction of a subject. With conventional multispectral imaging, a dedicated imaging system was necessary for imaging with multiple cameras or to perform imaging multiple times. There has been a desire for multispectral imaging using a regular digital camera, without use of such a dedicated imaging system. An image sensor that can perform multispectral imaging has thus been proposed (see JP2010-212969A (PTL 1)).

### CITATION LIST

### Patent Literature

PTL 1: JP2010-212969A

### SUMMARY OF INVENTION

With a regular digital camera, a single panel image sensor and a color filter array (CFA) are used. Color reproducibility can be improved by making the color filter array (CFA) multiband. As the number of bands increases, however, the sample density for each band decreases, leading to problems such as the occurrence of false colors upon demosaicing.

Accordingly, the present invention has been conceived in light of the above problems, and it is an object thereof to provide an image processing system that can perform demosaicing that suppresses the occurrence of false colors based on an original image signal generated by an image sensor having a multiband CFA.

In order to resolve the above-described problems, an image processing system according to the present invention is for interpolating color signal components from an original image signal formed by a plurality of pixel signals each including any of first through m^{th} (m being an integer three or greater) color signal components, so that all of the pixel signals forming the original image signal include the first through m^{th} color signal components, the image processing system including: a reception unit configured to receive the original image signal; a derivative calculation unit configured to calculate a derivative for the pixel signals using two pixels of a same color sandwiching a pixel corresponding to the pixel signals; a reference image creation unit configured to create a primary reference image using the first color signal component in the original image signal; and an interpolated image creation unit configured to create an interpolated image by interpolating all of the color signal components using the primary reference image, wherein at least one of the primary reference image and the interpolated image is created using the derivative.

According to the image processing system with the above structure according to the present invention, a derivative is used during creation of a reference image or an interpolated image, and therefore interpolation is performed based on a local region of an actual captured image. As a result, demosaicing that suppresses the occurrence of false colors while promoting the use of multiband in a CFA is possible.

### BRIEF DESCRIPTION OF DRAWINGS

The present invention will be further described below with reference to the accompanying drawings, wherein:

FIG. 1 is a block diagram schematically illustrating a digital camera including an image processing system according to Embodiment 1 of the present invention;

FIG. 2 illustrates the arrangement of color filters within a CFA;

FIG. 3 is a block diagram schematically illustrating the structure of an image signal processing unit;

FIG. 4 is a conceptual diagram illustrating the structure of G, Cy, Or, B, and R original image signal components;

FIG. 5 is a conceptual diagram illustrating demosaicing performed by an MB demosaicing unit of Embodiment 1;

FIG. 6 is a block diagram schematically illustrating the structure of the MB demosaicing unit of Embodiment 1;

FIG. 7 is a conceptual diagram illustrating demosaicing performed by an MB demosaicing unit of Embodiment 2;

FIG. 8 is a block diagram schematically illustrating the structure of the MB demosaicing unit of Embodiment 2;

FIG. 9 is a conceptual diagram illustrating demosaicing performed by an MB demosaicing unit of Embodiment 3;

FIG. 10 is a block diagram schematically illustrating the structure of the MB demosaicing unit of Embodiment 3;

FIG. 11 is a conceptual diagram illustrating demosaicing performed by an MB demosaicing unit of Embodiment 4;

FIG. 12 is a block diagram schematically illustrating the structure of the MB demosaicing unit of Embodiment 4;

FIG. 13 is a conceptual diagram illustrating demosaicing performed by an MB demosaicing unit of Embodiment 5;

FIG. 14 is a block diagram schematically illustrating the structure of the MB demosaicing unit of Embodiment 5;

FIG. 15 is a conceptual diagram illustrating demosaicing performed by an MB demosaicing unit of Embodiment 6;

FIG. 16 is a block diagram schematically illustrating the structure of the MB demosaicing unit of Embodiment 6; and

FIG. 17 is a conceptual diagram illustrating demosaicing to interpolate color signal components via color differences.

### DESCRIPTION OF EMBODIMENTS

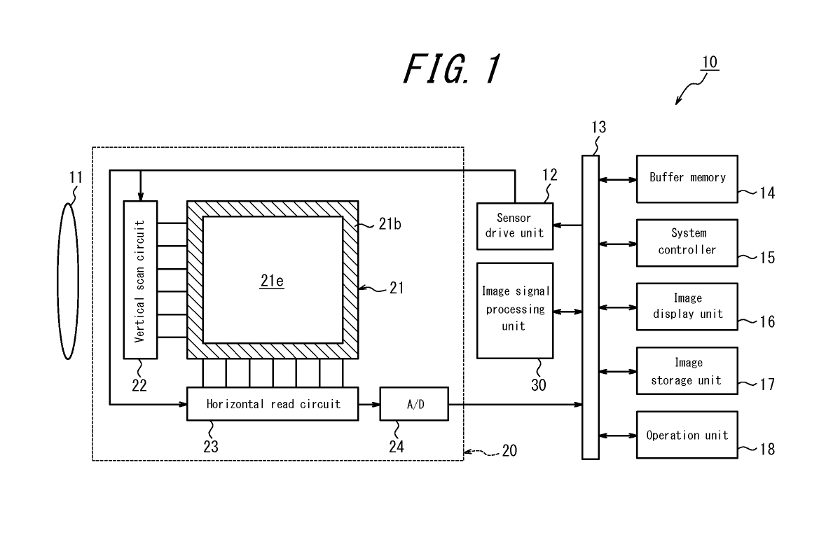

With reference to the drawings, the following describes embodiments of an image processing system in which the present invention is adopted. FIG. 1 is a block diagram schematically illustrating a digital camera including an image processing system according to Embodiment 1 of the present invention.

A digital camera 10 includes an imaging optical system 11, an image sensor 20, a sensor drive unit 12, a system bus 13, an image signal processing unit 30, a buffer memory 14, a system controller 15, an image display unit 16, an image storage unit 17, an operation unit 18, and the like.

The imaging optical system 11 is positioned vertically so that the light axes thereof traverse the center of a light receiving unit 21 in the image sensor 20 and unite on the image sensor 20. The imaging optical system 11 is formed by a plurality of lenses (not illustrated) and forms an optical image of a subject on the light receiving unit 21.

The image sensor 20 is, for example, a CMOS area sensor and includes the light receiving unit 21, a vertical scan circuit 22, a horizontal read circuit 23, and an A/D converter 24. As described above, an optical image of a subject is formed by the imaging optical system 11 on the light receiving unit 21.

A plurality of pixels (not illustrated) are arranged in a matrix on the light receiving unit 21. Furthermore, on the light receiving unit 21, an optical black (OB) region 21b and an active imaging region 21e are established. The light-receiving surface of OB pixels positioned in the OB region 21b is shielded from light, and these OB pixels output an OB pixel signal (dark current) serving as a standard for the color black. The active imaging region 21e is covered by a CFA (not illustrated in FIG. 1), and each pixel is covered by one band of a five-band color filter.

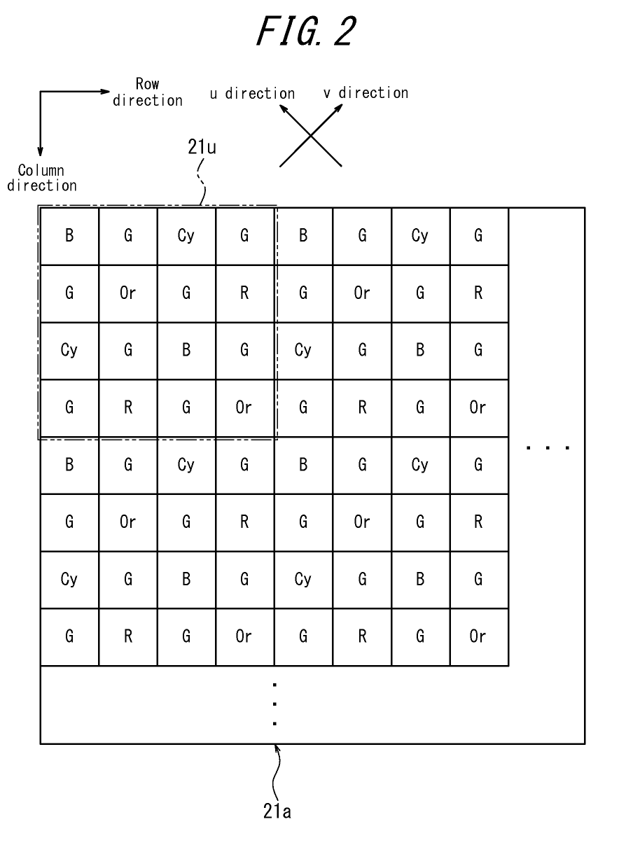

As illustrated in FIG. 2, a five-band color filter is provided in a CFA 21a, including a green (G) color filter, a cyan (Cy) color filter, an orange (Or) color filter, a blue (B) color filter, and a red (R) color filter. Accordingly, in each pixel, a pixel signal is generated in correspondence with the amount of received light passing through the band of the corresponding color filter.

In the CFA 21a, a 4×4 color filter repetition unit 21u is repeatedly placed in the row direction and the column direction. As illustrated in FIG. 2, eight G color filters, two Cy color filters, two Or color filters, two B color filters, and two R color filters are placed in the color filter repetition unit 21u.

In the CFA 21a, the Cy color filters, the Or color filters, the B color filters, and the R color filters are positioned in a checkerboard pattern with the G color filters. In other words, the G color filters are repeatedly provided in every other pixel of every row and column. For example, staring from the upper-left corner of FIG. 2, G color filters are provided in columns 2 and 4 of rows 1 and 3. Furthermore, G color filters are provided in columns 1 and 3 of rows 2 and 4.

The rows and columns containing the G color filters, B color filters, and Cy color filters repeatedly occur every other pixel in the column direction and the row direction. For example, in FIG. 2, B color filters are provided in row 1, column 1 and in row 3, column 3, whereas Cy color filters are provided in row 1, column 3 and in row 3, column 1.

The rows and columns containing the G color filters, R color filters, and Or color filters also repeatedly occur every other pixel in the column direction and the row direction. For example, in FIG. 2, R color filters are provided in row 2, column 4 and in row 4, column 2, whereas Or color filters are provided in row 2, column 2 and in row 4, column 4.

In the above-described color filter repetition unit 21u, the proportion of G color filters is the largest, accounting for 50% of the total. For any pixel, the band of the color filter corresponding to the diagonally adjacent pixels is the same.

For example, for any of the G color filters, the diagonally adjacent color filters are all G color filters. Accordingly, diagonally to the upper right and the lower left of any G color filter, G color filters of the same band are provided. G color filters of the same band are also provided diagonally to the lower right and the upper left.

Each of the Cy color filters is sandwiched diagonally between R color filters and Or color filters. In greater detail, diagonally to the upper right and the lower left of any Cy color filter, Or color filters of the same band are provided. R color filters of the same band are provided diagonally to the lower right and the upper left.

The Or color filters, B color filters, and R color filters are all similar, with diagonally adjacent color filters being color filters of the same band.

In an image sensor provided with the above-described CFA 21a, pixel signals are generated in correspondence with the amount of received light passing through the band. The row of the pixel caused to output a pixel signal is selected by the vertical scan circuit 22, and the column of the pixel caused to output a pixel signal is selected by the horizontal read circuit 23 (see FIG. 1).

The vertical scan circuit 22 and the horizontal read circuit 23 are driven by the sensor drive unit 12 and controlled so that a pixel signal is output one pixel at a time. The output pixel signal is converted into a digital signal by the A/D converter 24. The pixel signals of every pixel provided in the light receiving unit 21 are set as an original image signal (raw image data) for one frame.

The image sensor 20, buffer memory 14, image signal processing unit 30, system controller 15, image display unit 16, image storage unit 17, operation unit 18, and sensor drive unit 12 are electrically connected via the system bus 13. These components connected to the system bus 13 can transmit and receive a variety of signals and data to and from each other over the system bus 13.

The original image signal output from the image sensor 20 is transmitted to the buffer memory 14 and stored. The buffer memory 14 is an SDRAM or the like with a relatively high access speed and is used as a work area for the image signal processing unit 30. The buffer memory 14 is also used as a work area when the system controller 15 executes a program to control the units of the digital camera 10.

The image signal processing unit 30 performs demosaicing, described in detail below, on an original image signal to generate an interpolated image signal. Furthermore, the image signal processing unit 30 performs predetermined image processing on the interpolated image signal. Note that as necessary, the interpolated image signal is converted into an RGB image signal.

The interpolated image signal and RGB image signal on which predetermined image processing has been performed are transmitted to the image display unit 16 and the image storage unit 17. The image display unit 16 includes a multiple primary color monitor (not illustrated in FIG. 1) and an RGB monitor (not illustrated in FIG. 1). Images corresponding to the received interpolated image signal and RGB image signal are displayed on the multiple primary color monitor and the RGB monitor. The interpolated image signal and the RGB image signal transmitted to the image storage unit 17 are stored therein.

The units of the digital camera 10 are controlled by the system controller 15. Control signals for controlling the units are input from the system controller 15 to the units via the system bus 13.

Note that the image signal processing unit 30 and the system controller 15 can be configured as software executing on an appropriate processor, such as a central processing unit (CPU), or configured as a dedicated processor specific to each process.

The system controller 15 is connected to an input unit 18 having an input mechanism including a power button (not illustrated), a release button (not illustrated), a dial (not illustrated), and the like. A variety of operation input for the digital camera 10 is detected from the user by the input unit 18. In accordance with the operation input detected by the input unit 18, the system controller 15 controls the units of the digital camera 10.

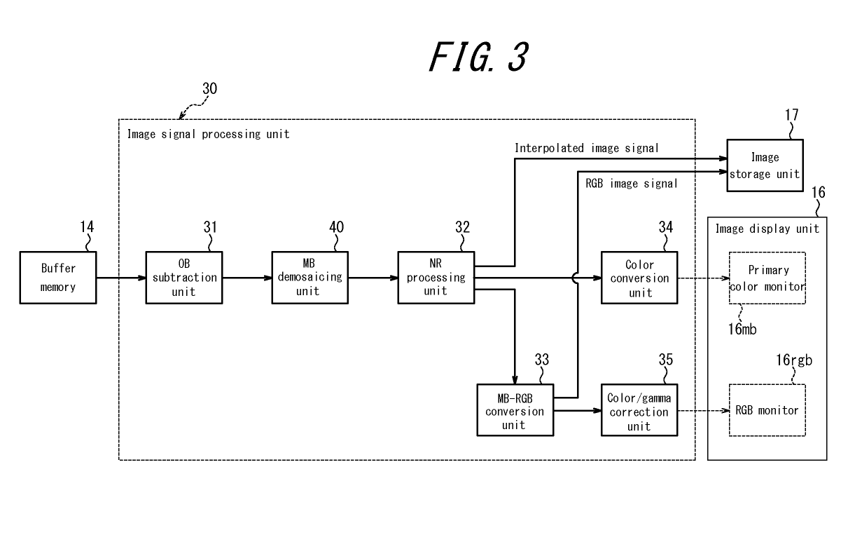

Next, the structure of the image signal processing unit 30 is described with reference to FIG. 3. The image signal processing unit 30 includes an OB subtraction unit 31, a multiband (MB) demosaicing unit 40 (image processing system), an NR processing unit 32, an MB-RGB conversion unit 33, a color conversion unit 34, and a color/gamma correction unit 35.

The original image signal output from the buffer memory 14 is transmitted to the OB subtraction unit 31. In the OB subtraction unit 31, the black level of each pixel signal is adjusted by subtracting the OB pixel signal generated in the OB pixel from each pixel signal.

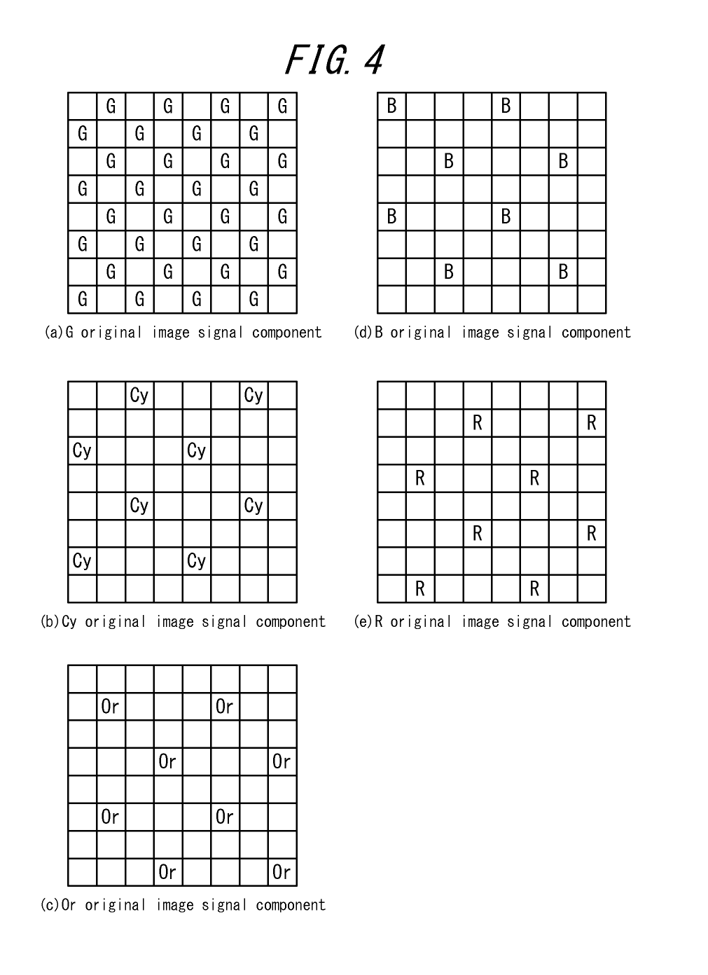

The pixel signal output from the OB subtraction unit 31 is transmitted to the MB demosaicing unit 40. As described above, the pixel signal forming the original image signal only includes one color signal component among the five bands. In other words, as illustrated in FIG. 4, the original image signal is formed by a G original image signal component (see (a)), a Cy original image signal component (see (b)), an Or original image signal component (see (c)), a B original image signal component (see (d)), and an R original image signal component (see (e)). As described below, all color signal components are interpolated through the demosaicing by the MB demosaicing unit 40. In other words, all pixel signals are interpolated so as to include five color signal components.

The original image signal on which demosaicing has been performed is transmitted to the NR processing unit 32 as an interpolated image signal. In the NR processing unit 32, noise is removed from the interpolated image signal. The interpolated image signal with noise removed is transmitted to the image storage unit 17 and stored therein. The interpolated image signal with noise removed is also transmitted to the MB-RGB conversion unit 33 and the color conversion unit 34.

In the MB-RGB conversion unit 33, RGB conversion is performed on the interpolated image signal. The interpolated image signal formed from color signal components in five bands is converted to an RGB image signal formed from color signal components in the three RGB bands. The RGB image signal is transmitted to the image storage unit 17 and stored therein. The RGB image signal is also transmitted to the color/gamma correction unit 35.

In the color conversion unit 34, color conversion is performed on the interpolated image signal. The color converted, interpolated image signal is transmitted to a multiple primary color monitor 16 mb, and an image corresponding to the interpolated image signal is displayed.

In the color/gamma correction unit 35, color correction and gamma correction are performed on the RGB image signal. The RGB image signal on which these corrections have been performed is transmitted to an RGB monitor 16rgb, and an image corresponding to the RGB image signal is displayed.

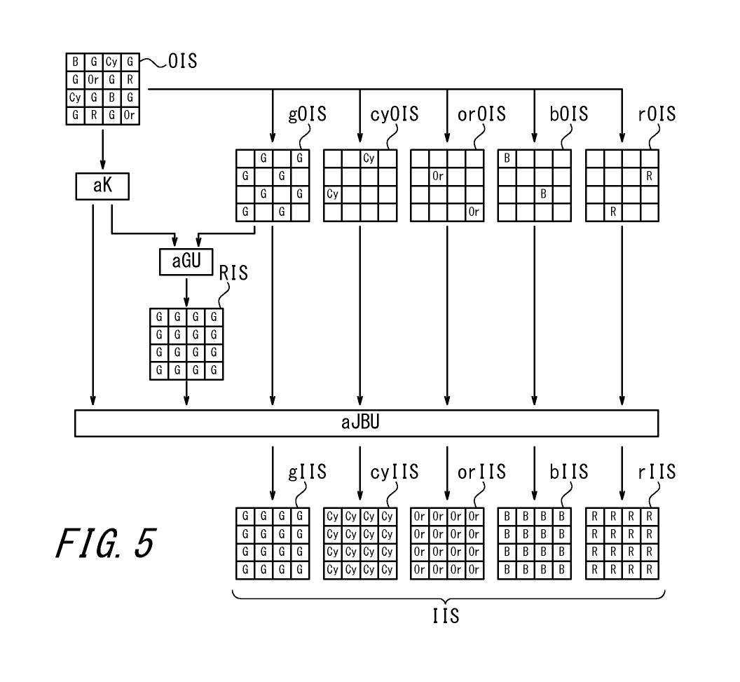

Next, demosaicing is described with reference to FIG. 5, which is a conceptual diagram illustrating demosaicing performed by the MB demosaicing unit 40.

As described above, in an original image signal OIS, each pixel signal only includes one color signal component among the five bands. The original image signal OIS is divided into a G original image signal component gOIS, a Cy original image signal component cyOIS, an Or original image signal component or OIS, a B original image signal component bOIS, and an R original image signal component rOIS.

Using all pixel signals in the original image signal OIS, an adaptive kernel function is calculated for every pixel (see aK). Using the adaptive kernel function and the G original image signal component gOIS, the pixel signals that are lacking in the G original image signal component gOIS are interpolated with an adaptive Gaussian interpolation method, so that a reference image signal RIS (primary reference image) is generated (see aGU).

Using the adaptive kernel function, the reference image signal RIS, and the G original image signal component gOIS, lacking pixel signals in the G original image signal component gOIS are interpolated with an adaptive joint bilateral interpolation method, so that a G interpolated image signal component gIIS is generated.

Similar processing is performed using the Cy original image signal component cyOIS instead of the G original image signal component gOIS, so that a Cy interpolated image signal component cyIIS is generated. Similarly, an Or interpolated image signal component orIIS, a B interpolated image signal component bIIS, and an R interpolated image signal component rIIS are generated. By generating pixel signals having all color signal components for all pixels, an interpolated image signal IIS is generated.

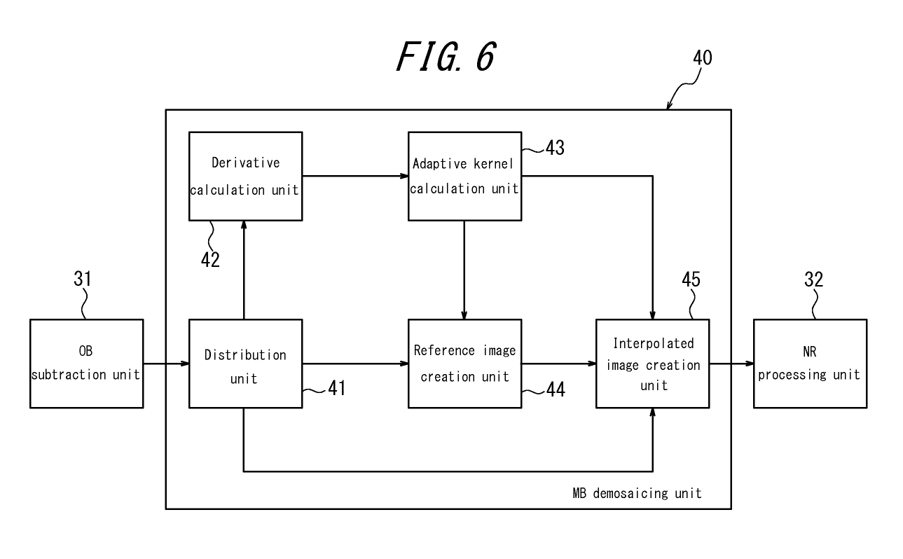

Next, the structure and functions of the MB demosaicing unit 40 that performs such demosaicing is described with reference to FIG. 6. The MB demosaicing unit 40 includes a distribution unit 41 (reception unit), a derivative calculation unit 42, an adaptive kernel calculation unit 43, a reference image creation unit 44, and an interpolated image creation unit 45.

The original image signal received by the MB demosaicing unit 40 is input into the distribution unit 41. In the distribution unit 41, color signal components are distributed to the derivative calculation unit 42, reference image creation unit 44, and interpolated image creation unit 45 as necessary.

All pixel signals forming the original image signal are transmitted to the derivative calculation unit 42. In the derivative calculation unit 42, derivatives in two directions (derivatives A and B) are calculated. In order to calculate the derivatives, each of the pixels is designated in order as a pixel of interest (not illustrated). The derivatives are calculated as the difference between the pixel signals for the pixels adjacent to the designated pixel of interest to the upper right and the lower left and the difference between the pixel signals for the pixels adjacent to the designated pixel of interest to the lower right and the upper left.

Note that, as described above, for any pixel that is the pixel of interest, the pixel signals generated in the pixels to the upper right and the lower left are for the same color signal component, and the pixel signals generated in the pixels to the lower right and the upper left are for the same color signal component. Therefore, the above derivatives indicate the local pixel gradient in the diagonal directions centering on the pixel of interest. The derivatives calculated for all pixels are transmitted to the adaptive kernel calculation unit 43.

Based on the derivatives and on the pixel signals, the adaptive kernel calculation unit 43 calculates an adaptive kernel function for each pixel. In order to calculate the adaptive kernel function, each of the pixels is designated in order as a pixel of interest. Pixels in a 7×7 region around the pixel of interest are designated as surrounding pixels. Once the pixel of interest and the surrounding pixels have been designated, the inverse matrix of a covariance matrix Cₓ is calculated for the pixel of interest.

The inverse matrix is calculated by substituting the derivatives of the pixel of interest and of the surrounding pixels into Equation (1).

$${C}_{x}^{- 1} = \frac{1}{\vert {N}_{x} \vert} ( \begin{matrix}{\sum }_{{x}_{j} ∈ {N}_{x}} {z}_{u} ( {x}_{j} ) {z}_{u} ( {x}_{j} ) & {\sum }_{{x}_{j} ∈ {N}_{x}} {z}_{u} ( {x}_{j} ) {z}_{v} ( {x}_{j} ) \\ {\sum }_{{x}_{j} ∈ {N}_{x}} {z}_{u} ( {x}_{j} ) {z}_{v} ( {x}_{j} ) & {\sum }_{{x}_{j} ∈ {N}_{x}} {z}_{v} ( {x}_{j} ) {z}_{v} ( {x}_{j} )\end{matrix} ) \qquad ( 1 )$$

In Equation (1), Nₓ is a pixel position set for the surrounding pixels, and |Nₓ| is the number of pixels in the pixel position set. Furthermore, zᵤ(xⱼ) is the derivative of surrounding pixel xⱼ in the u direction, and zᵥ(xⱼ) is the derivative of surrounding pixel xⱼ in the v direction. Note that as illustrated in FIG. 2, the u direction is the direction from the lower right to the upper left, and the v direction is the direction from the lower left to the upper right.

Once the covariance matrix for the pixel of interest is calculated, a parameter μₓ representing the magnitude of the kernel function for the pixel of interest is then calculated. In order to calculate the parameter μₓ, eigenvalues λ₁ and λ₂ for the covariance matrix Cₓ are calculated. The product of the eigenvalues λ₁×λ₂ is compared with a threshold S. If the product of the eigenvalues λ₁×λ₂ is equal to or greater than the threshold S, the parameter μₓ is calculated as 1. Conversely, if the product of the eigenvalues λ₁×λ₂ is less than the threshold S, the parameter μₓ is calculated as the fourth root of (S/(λ₁×λ₂)).

After calculation of the parameter μₓ, the adaptive kernel function is calculated for the pixel of interest. The adaptive kernel function kₓ(xⱼ−x) is calculated with Equation (2).

$${k}_{x} ( {x}_{i} - x ) = exp [ - \frac{{( {x}_{i} - x )}^{T} {R}^{T} {C}_{x}^{- 1} R ( {x}_{i} - x )}{2 {h}^{2} {μ}_{x}^{2}} ] \qquad ( 2 )$$

In Equation (2), xⱼ represents the coordinates of the surrounding pixels, x represents the coordinates of the pixel of interest, R represents a 45° rotation matrix, and h is a predetermined design parameter, set for example to 1.

The adaptive kernel function kₓ(xⱼ−x) calculated for each pixel is transmitted to the reference image creation unit 44 and the interpolated image creation unit 45. In the reference image creation unit 44, the G color signal component (first color signal component) with the largest number of elements in the original image signal is transmitted from the distribution unit 41. In the reference image creation unit 44, interpolation of the G color signal components in only one half of all pixels is performed with an adaptive Gaussian interpolation method, so that a reference image signal is generated.

Interpolation of lacking pixel signals in the G original image signal component with the adaptive Gaussian interpolation method is now described. Each of the pixels for which the G original image signal component is to be interpolated, i.e. the pixels not including a G color signal component in the original image signal, is designated in order as a pixel of interest. Pixels in a 7×7 region around the pixel of interest are designated as surrounding pixels.

The pixel signal for the pixel of interest is calculated with Equation (3), based on the G color signal component of the surrounding pixels and on the adaptive kernel function.

$${S}_{x} = \frac{1}{{ω}_{x}} {\sum }_{i} {M}_{{x}_{i}} {S}_{{x}_{i}} k ( {x}_{i} - x ) \qquad ( 3 )$$

Note that ωₓ is calculated with Equation (4). Mₓᵢ is a binary mask set to 1 when the surrounding pixel has a G color signal component and set to 0 when the surrounding pixel does not have a G color signal component. Sₓᵢ is the G color component of the surrounding pixel.

$${ω}_{x} = {\sum }_{i} {M}_{{x}_{i}} k ( {x}_{i} - x ) \qquad ( 4 )$$

The reference image signal formed by the G original image signal component and by the G color signal components interpolated for all pixels designated as pixels of interest are transmitted to the interpolated image creation unit 45. As described above, the adaptive kernel function kₓ(xⱼ−x) and the reference image signal are transmitted from the adaptive kernel calculation unit 43 and the reference image creation unit 44 to the interpolated image creation unit 45. Furthermore, as described above, the G original image signal component, Cy original image signal component, Or original image signal component, B original image signal component, and R original image signal component are transmitted in order from the distribution unit 41 to the interpolated image creation unit 45.

In the interpolated image creation unit 45, the non-generated color signal components are interpolated for all pixels with an adaptive joint bilateral interpolation method. For example, using the G color signal components existing for only half of the pixels, the G color signal components for the other pixels are interpolated.

Similarly, using the Cy color signal components, Or color signal components, B color signal components, and R color signal components existing in only one eighth of the pixels, the Cy color signal components, Or color signal components, B color signal components, and R color signal components for the other pixels are interpolated. Interpolating all of the color signal components yields an interpolated image signal formed so that all pixel signals have all color signal components. Note that while interpolation is performed during creation of the reference image for the G color signal components, interpolation using the reference image is performed separately.

Interpolation of each color signal component with the adaptive joint bilateral interpolation method is now described, using the G color signal component as an example. Each of the pixels for which the G color signal component is to be interpolated, i.e. the pixels not including a G color signal component in the original image signal, is designated in order as a pixel of interest. Pixels in a 7×7 region around the pixel of interest are designated as surrounding pixels.

The color signal component for the pixel of interest is calculated with Equation (5), based on the G color signal component of the surrounding pixels, the adaptive kernel function, and the reference image signal.

$${S}_{x} = \frac{1}{{ω}_{x}} {\sum }_{i} {M}_{{x}_{i}} {S}_{{x}_{i}} k ( {x}_{i} - x ) r ( {I}_{{x}_{i}} - {I}_{x} ) \qquad ( 5 )$$

In Equation (5), Iₓᵢ represents the pixel value of a surrounding pixel in the reference image, and Iₓ represents the pixel value of the pixel of interest in the reference image. Furthermore, r(Iₓᵢ−Iₓ) is a weight corresponding to the difference between the pixel values of the pixel of interest and the surrounding pixel.

Interpolation of the G color signal component for the pixel of interest yields a G interpolated image signal component. Subsequently, the Cy color signal component, Or color signal component, B color signal component, and R color signal component are similarly interpolated, yielding a Cy interpolated image signal component, Or interpolated image signal component, B interpolated image signal component, and R interpolated image signal component. By thus interpolating all color signal components, an interpolated image signal is generated.

According to the image processing system of Embodiment 1 with the above structure, derivatives are calculated for each pixel, a reference image is created based on the derivatives, i.e. gradient information, and an interpolated image is created based on the reference image and the gradient information.

Typically in a natural image, it is known that correlation is strong between bands in high frequency components. Accordingly, the image in each band has the same edge structure. Therefore, the gradient information is assumed to be equivalent for all of the bands. Based on this assumption, during creation of the reference image and the interpolated image, the derivative of any color signal component can be used to calculate the adaptive kernel function for interpolation of other color signal components.

In Embodiment 1, during creation of the reference image as well, an adaptive kernel function is used by using gradient information for every pixel. Therefore, in the reference image, the occurrence of false images can be reduced. In this way, by performing color interpolation using a reference image with reduced occurrence of false images and an adaptive kernel function, the occurrence of false images can be greatly reduced in the various color signal components.

As a result, according to the image processing system of Embodiment 1, an interpolated image signal with reduced occurrence of false colors can be generated from an original image signal formed from multiband color signal components.

Furthermore, in Embodiment 1, the parameter μₓ is calculated based on the product of eigenvalues of a covariance function and is used for calculation of the adaptive kernel function. As described above, the parameter μₓ is a parameter representing the magnitude of the kernel function and is calculated based on eigenvalues. Therefore, the magnitude of the kernel function can be appropriately set for each pixel of interest.

Next, an image processing system according to Embodiment 2 of the present invention is described. Embodiment 2 differs from Embodiment 1 in the demosaicing and the structure of the MB demosaicing unit. Embodiment 2 is described below, focusing on the differences from Embodiment 1. Note that components having the same function and structure as in Embodiment 1 are labeled with the same reference signs.

In Embodiment 2, the structure and function of components in the digital camera other than the MB demosaicing unit are the same as in Embodiment 1.

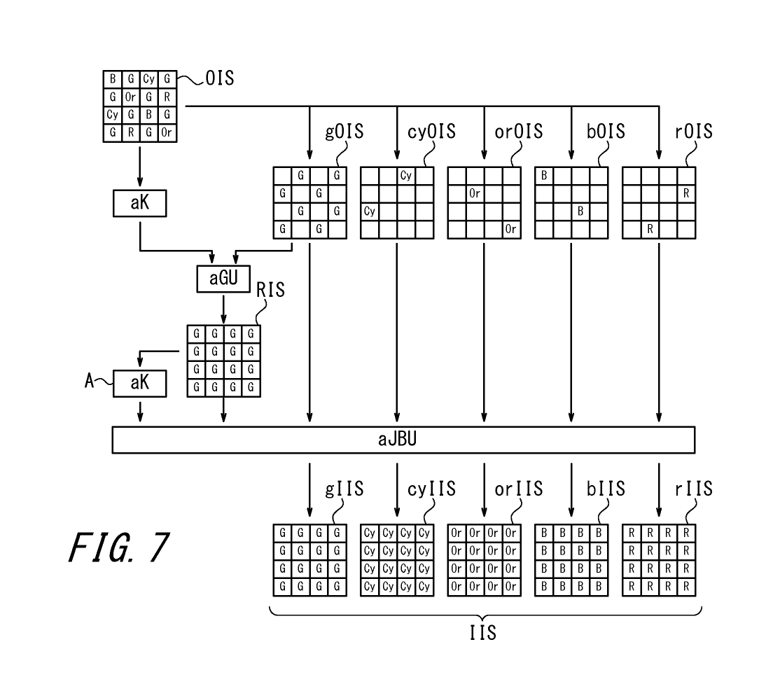

The demosaicing performed in Embodiment 2 is described with reference to FIG. 7, which is a conceptual diagram illustrating demosaicing performed by the MB demosaicing unit of Embodiment 2.

In Embodiment 2, the adaptive kernel function used in the adaptive joint bilateral interpolation method differs from Embodiment 1. In Embodiment 1, an adaptive kernel function calculated using all pixel signals of the original image signal OIS is used, whereas in Embodiment 2, an adaptive kernel function calculated using the reference image signal RIS (see reference sign A) is used.

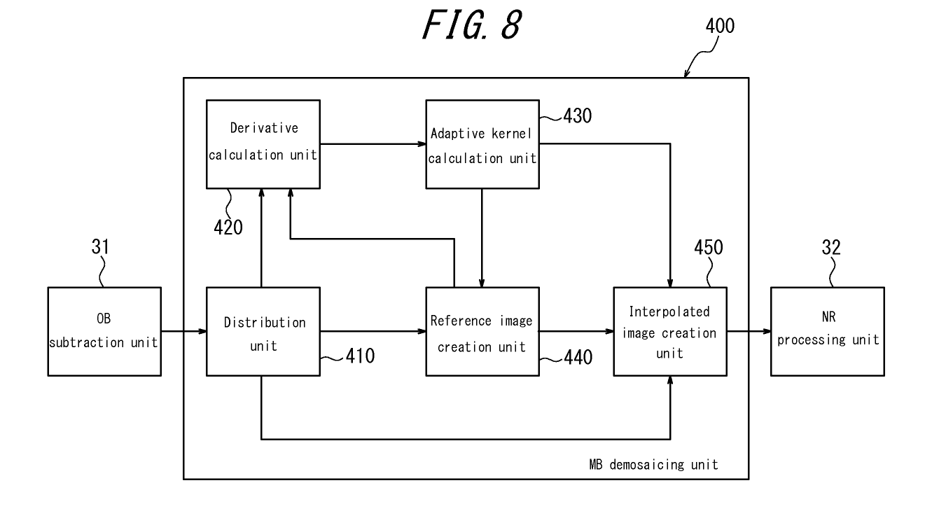

Next, the structure and functions of an MB demosaicing unit 400 that performs such demosaicing is described with reference to FIG. 8. The MB demosaicing unit 400 in Embodiment 2 includes a distribution unit 410, a derivative calculation unit 420, an adaptive kernel calculation unit 430, a reference image creation unit 440, and an interpolated image creation unit 450.

In Embodiment 2, a portion of the functions of the derivative calculation unit 420, adaptive kernel calculation unit 430, and reference image creation unit 440 differ from Embodiment 1. By the derivative calculation unit 420, adaptive kernel calculation unit 430, and reference image creation unit 440 functioning in a similar way as in Embodiment 1, a reference image signal is generated.

Unlike Embodiment 1, the reference image signal is transmitted to the derivative calculation unit 420 and the adaptive kernel calculation unit 430. In the derivative calculation unit 420, derivatives in two directions (derivative C) are calculated for each pixel using the G color signal components in the reference image signal. Furthermore, unlike Embodiment 2, the adaptive kernel calculation unit 430 calculates the adaptive kernel function as well using the derivatives calculated based on the reference image signal.

The adaptive kernel function calculated based on the reference image signal is transmitted to the interpolated image creation unit 450 instead of the adaptive kernel function calculated based on the original image signal. In the interpolated image creation unit 450, each color signal component is interpolated using the adaptive kernel function calculated based on the reference image signal.

In Embodiment 2 as well, according to the image processing system with the above structure, derivatives are calculated for each pixel, a reference image is created based on the derivatives, i.e. gradient information, and an interpolated image signal can be created based on the reference image and the gradient information. As a result, an interpolated image signal with reduced occurrence of false colors can be generated from an original image signal formed from multiband color signal components.

Next, an image processing system according to Embodiment 3 of the present invention is described. Embodiment 3 differs from Embodiment 1 in the demosaicing and the structure of the MB demosaicing unit. Embodiment 3 is described below, focusing on the differences from Embodiment 1. Note that components having the same function and structure as in Embodiment 1 are labeled with the same reference signs.

In Embodiment 2, the structure and function of components in the digital camera other than the MB demosaicing unit are the same as in Embodiment 1.

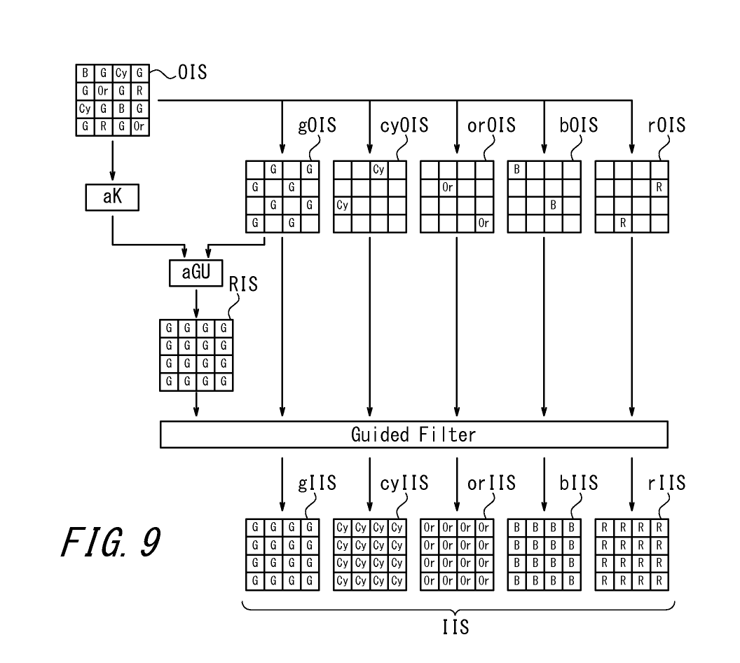

The demosaicing performed in Embodiment 3 is described with reference to FIG. 9, which is a conceptual diagram illustrating demosaicing performed by the MB demosaicing unit of Embodiment 3.

Embodiment 3 differs from Embodiment 1 in that a guided filter (see “Guided Filter”) is used instead of the adaptive joint bilateral interpolation method for interpolation of each color signal component. Note that for calculation of the guided filter, the adaptive kernel function is not necessary.

Accordingly, as in Embodiment 1, the adaptive kernel function is calculated (see aK), and using the G original image signal component gOIS, the reference image signal RIS is generated. Next, based on the reference image signal RIS, the guided filter is applied.

The G color signal component is interpolated with an interpolation method using the guided filter, so that a G interpolated image signal component gIIS is generated. Similar processing is performed using the Cy color signal component instead of the G color signal component, so that a Cy interpolated image signal component cyIIS is generated. Similarly, an Or interpolated image signal component orIIS, a B interpolated image signal component bIIS, and an R interpolated image signal component rIIS are generated. By generating pixel signals having all color signal components for all pixels, an interpolated image IIS is generated.

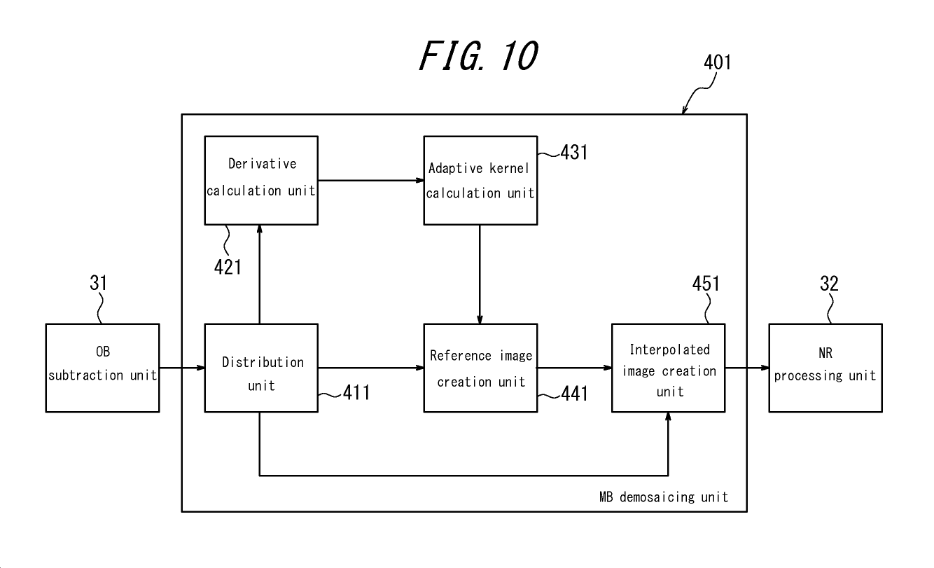

Next, the structure and functions of the MB demosaicing unit 401 that performs such demosaicing is described with reference to FIG. 10. As in Embodiment 1, the MB demosaicing unit 401 includes a distribution unit 411, a derivative calculation unit 421, an adaptive kernel calculation unit 431, a reference image creation unit 441, and an interpolated image creation unit 451.

The functions of the distribution unit 411, derivative calculation unit 421, adaptive kernel calculation unit 431, and reference image creation unit 441 are the same as in Embodiment 1. Accordingly, as in Embodiment 1, a reference image signal is generated with an adaptive Gaussian interpolation method.

Unlike Embodiment 1, in the interpolated image creation unit 451, interpolation of the G color signal component is performed by applying the guided filter. Similarly, interpolation of the Cy color signal component, Or color signal component, B color signal component, and R color signal component is performed.

First, the guided filter is described. For the guided filter, each of the pixels is designated in order as a pixel of interest. Pixels in a 5×5 region around the pixel of interest are designated as surrounding pixels.

For a pixel of interest xp, coefficients (aₓₚ, bₓₚ) are calculated by the method of least squares so that the cost function E(aₓₚ, bₓₚ) in Equation (6) is minimized.

$$E ( {a}_{k} , {b}_{k} ) = \frac{1}{{ω}_{k}} {\sum }_{i} {M}_{i} ( {( {a}_{k} {I}_{i} + {b}_{k} - {p}_{i} )}^{2} + ɛ {a}_{k}^{2} ) \qquad ( 6 )$$

In Equation (6), ωₖ is the number of elements of the signal components existing around the pixel of interest. Mᵢ is a binary mask set to 1 when the surrounding pixel has a signal component and set to 0 when the surrounding pixel does not have a signal component. Parameters to be calculated are represented by aₓₚ and bₓₚ, and appropriate initial values are used at the start of calculation. Iᵢ is the reference image pixel value corresponding to the surrounding pixel. The pixel value of the signal component is pᵢ. A predetermined smoothing parameter is represented by ε.

The coefficients (aₓₚ, bₓₚ) are calculated for all pixels. In order to interpolate the G color signal component, each of the pixels not including a G color signal component in the original image signal is designated in order as a pixel of interest. Furthermore, pixels in a 5×5 region around the pixel of interest are designated as surrounding pixels.

A color signal component qᵢ for a pixel of interest xᵢ is calculated with Equation (7).

$${q}_{i} = \frac{1}{\vert ω \vert} {\sum }_{k \text{:} i ∈ {ω}_{k}} ( {a}_{k} {I}_{i} + {b}_{k} ) \qquad ( 7 )$$

In Equation (7), |ω| is the number of pixels including the pixel of interest and surrounding pixels, i.e. 25 in the case of a 5×5 layout. (aₓₚ, bₓₚ) are coefficients calculated in the guided filter for the surrounding pixels.

Interpolation of the G color signal component for the pixel of interest yields a G interpolated image signal component. Subsequently, the Cy color signal component, Or color signal component, B color signal component, and R color signal component are interpolated in the same way as the G color signal component, yielding a Cy interpolated image signal component, Or interpolated image signal component, B interpolated image signal component, and R interpolated image signal component. By thus interpolating all color signal components, an interpolated image signal is generated.

In Embodiment 3 as well, according to the image processing system with the above structure, derivatives are calculated for each pixel, a reference image is created based on the derivatives, i.e. gradient information, and an interpolated image signal can be created based on the reference image. As a result, an interpolated image signal with reduced occurrence of false colors can be generated from an original image signal formed from multiband color signal components.

Next, an image processing system according to Embodiment 4 of the present invention is described. Embodiment 4 differs from Embodiment 1 in the demosaicing and the structure of the MB demosaicing unit. Embodiment 4 is described below, focusing on the differences from Embodiment 1. Note that components having the same function and structure as in Embodiment 1 are labeled with the same reference signs.

In Embodiment 4, the structure and function of components in the digital camera other than the MB demosaicing unit are the same as in Embodiment 1.

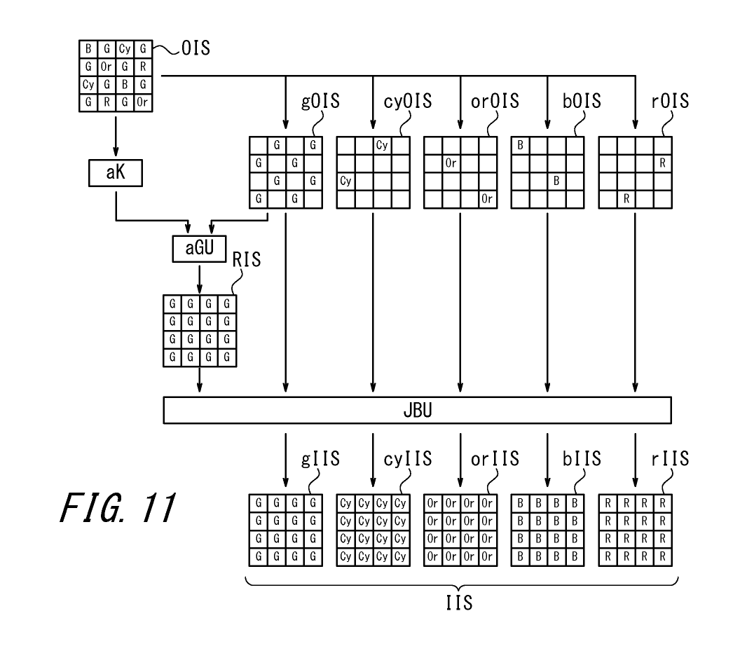

The demosaicing performed in Embodiment 4 is described with reference to FIG. 11, which is a conceptual diagram illustrating demosaicing performed by the MB demosaicing unit of Embodiment 4.

Embodiment 4 differs from Embodiment 1 in that a joint bilateral interpolation method that does not use an adaptive kernel function (see JBU) is used instead of the adaptive joint bilateral interpolation method for interpolation of all of the color signal components.

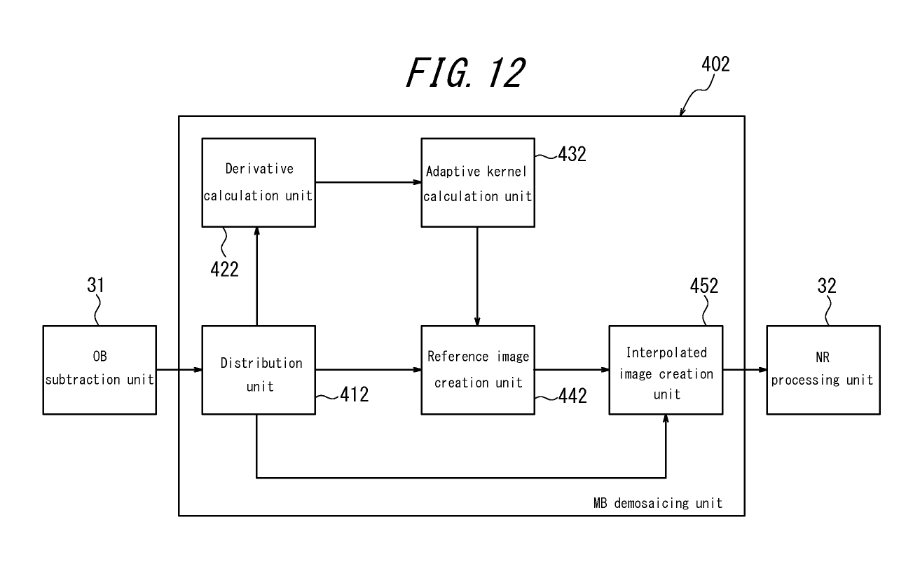

Next, the structure and functions of the MB demosaicing unit that performs such demosaicing is described with reference to FIG. 12. The MB demosaicing unit 402 in Embodiment 2 includes a distribution unit 412, a derivative calculation unit 422, an adaptive kernel calculation unit 432, a reference image creation unit 442, and an interpolated image creation unit 452.

The functions of the distribution unit 412, derivative calculation unit 422, adaptive kernel calculation unit 432, and reference image creation unit 452 are the same as in Embodiment 1. Accordingly, as in Embodiment 1, a reference image signal is generated with an adaptive Gaussian interpolation method.

Unlike Embodiment 1, in the interpolated image creation unit 452, the G color signal component, Cy color signal component, Or color signal component, B color signal component, and R color signal component are interpolated with a joint bilateral interpolation method. In the joint bilateral interpolation method, the color signal component of the pixel of interest is calculated by setting k(xᵢ−x) not to the adaptive kernel function in Equation (4), but rather to a weight that decreases in accordance with the distance from the pixel of interest to the surrounding pixel.

In Embodiment 4 as well, according to the image processing system with the above structure, derivatives are calculated for each pixel, a reference image is created based on the derivatives, i.e. gradient information, and an interpolated image signal can be created based on the reference image. As a result, an interpolated image signal with reduced occurrence of false colors can be generated from an original image signal formed from multiband color signal components.

Note that since the color signal components are interpolated with a joint bilateral interpolation method that does not use an adaptive kernel function, the effect of suppressing the occurrence of false colors is achieved to a lesser degree than with Embodiment 1. Since an adaptive kernel function is used for creation of the reference image itself, however, the occurrence of false colors in the reference image is reduced, as described above. Therefore, as compared to creating the interpolated image with well-known linear interpolation, the effect of suppressing the occurrence of false colors can be enhanced.

Next, an image processing system according to Embodiment 5 of the present invention is described. Embodiment 5 differs from Embodiment 1 in the demosaicing and the structure of the MB demosaicing unit. Embodiment 5 is described below, focusing on the differences from Embodiment 1. Note that components having the same function and structure as in Embodiment 1 are labeled with the same reference signs.

In Embodiment 5, the structure and function of components in the digital camera other than the MB demosaicing unit are the same as in Embodiment 1.

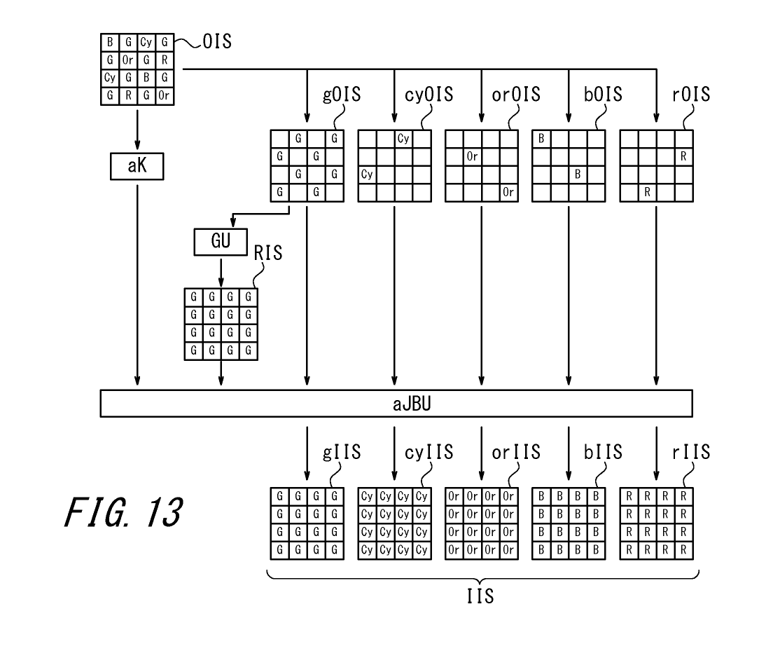

The demosaicing performed in Embodiment 5 is described with reference to FIG. 13, which is a conceptual diagram illustrating demosaicing performed by the MB demosaicing unit of Embodiment 5.

In Embodiment 5, a reference image is created by interpolating the G signal component with a regular Gaussian interpolation method, without using an adaptive kernel function (see GU).

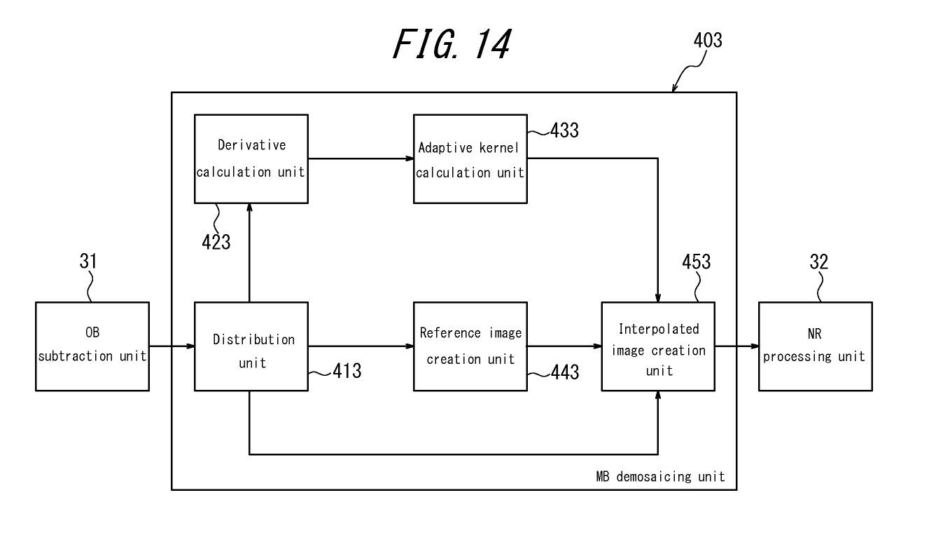

Next, the structure and functions of the MB demosaicing unit that performs such demosaicing is described with reference to FIG. 14. The MB demosaicing unit 403 in Embodiment 5 includes a distribution unit 413, a derivative calculation unit 423, an adaptive kernel calculation unit 433, a reference image creation unit 443, and an interpolated image creation unit 453.

The structure of the distribution unit 413, derivative calculation unit 423, and interpolated image creation unit 453 is the same as in Embodiment 1. As in Embodiment 1, the adaptive kernel calculation unit 433 calculates an adaptive kernel function for all pixels. Unlike Embodiment 1, however, the adaptive kernel function is transmitted only to the interpolated image creation unit 453, without being transmitted to the reference image creation unit 443.

In the reference image creation unit 443, unlike Embodiment 1, the G color signal component is interpolated for the G original image signal component with a Gaussian interpolation method so as to generate a reference image signal. The generated reference image signal is transmitted to the interpolated image creation unit 453.

As described above, the functions of the interpolated image creation unit 453 are the same as in Embodiment 1, and based on the adaptive kernel function, the reference image signal, and the color signal components of the original image signal, the color signal components are interpolated. Since pixel signals having all color signal components are generated for all pixels by interpolation of the color signal components, an interpolated image signal is generated.

In Embodiment 5 as well, according to the image processing system with the above structure, derivatives are calculated for each pixel, a reference image is created, and an interpolated image can be created based on the reference image and the derivatives, i.e. gradient information. As a result, an interpolated image signal with reduced occurrence of false colors can be generated from an original image signal formed from multiband color signal components.

Note that since the reference image is created with a regular Gaussian interpolation method without using an adaptive kernel function, the effect of suppressing the occurrence of false colors is achieved to a lesser degree than with Embodiment 1. Since the interpolated image is created using an adaptive kernel function, however, the occurrence of false colors can be reduced as compared to creating the interpolated image with well-known linear interpolation.

Next, an image processing system according to Embodiment 6 of the present invention is described. Embodiment 6 differs from Embodiment 1 in the demosaicing and the structure of the MB demosaicing unit. Embodiment 6 is described below, focusing on the differences from Embodiment 1. Note that components having the same function and structure as in Embodiment 1 are labeled with the same reference signs.

In Embodiment 6, the structure and function of components in the digital camera other than the MB demosaicing unit are the same as in Embodiment 1.

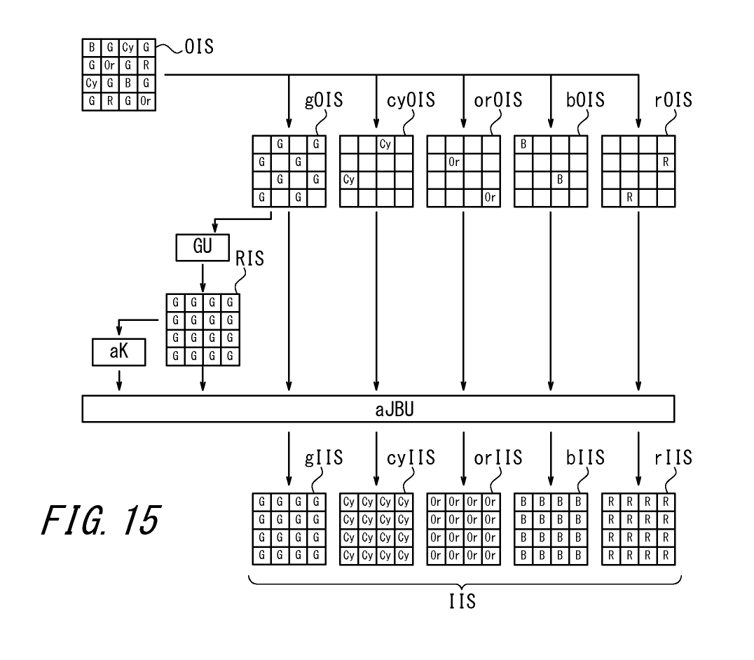

The demosaicing performed in Embodiment 6 is described with reference to FIG. 15, which is a conceptual diagram illustrating demosaicing performed by the MB demosaicing unit of Embodiment 6.

In Embodiment 6, a reference image is created by interpolating the G signal component with a regular Gaussian interpolation method, without using an adaptive kernel function (see GU). Furthermore, the adaptive kernel function used in the adaptive joint bilateral interpolation method differs from Embodiment 1. In Embodiment 6, as in Embodiment 2, an adaptive kernel function calculated using a reference image is used.

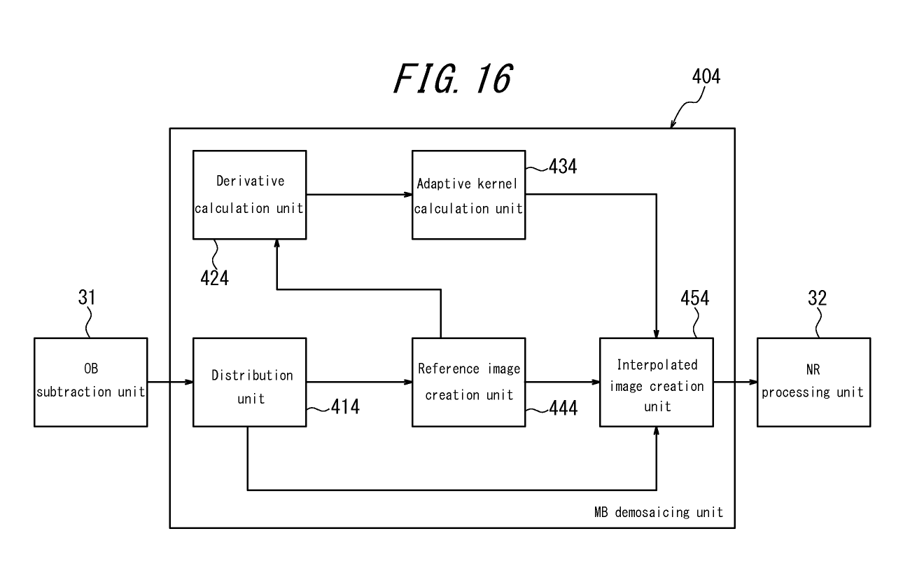

Next, the structure and functions of the MB demosaicing unit that performs such demosaicing is described with reference to FIG. 16. The MB demosaicing unit 404 in Embodiment 6 includes a distribution unit 414, a derivative calculation unit 424, an adaptive kernel calculation unit 434, a reference image creation unit 444, and an interpolated image creation unit 454.

In Embodiment 6, a portion of the functions of the distribution unit 414, derivative calculation unit 424, adaptive kernel calculation unit 434, reference image creation unit 444, and interpolated image creation unit 454 differ from Embodiment 1.

Unlike Embodiment 1, the color signal components are transmitted from the distribution unit 414 to the reference image creation unit 444 and the interpolated image creation unit 454, without being transmitted to the derivative calculation unit 424.

In the reference image creation unit 444, as in Embodiment 5, the G color signal component is interpolated for the G original image signal component with a regular Gaussian interpolation method, without using an adaptive kernel function, so as to generate a reference image signal. The generated reference image signal is transmitted to the derivative calculation unit 424 and the interpolated image creation unit 454, as in Embodiment 2.

In the derivative calculation unit 424, as in Embodiment 2, derivatives in two directions are calculated for each pixel using the G color signal components in the reference image signal. The calculated derivatives are transmitted to the adaptive kernel calculation unit 434. The adaptive kernel calculation unit 434 calculates the adaptive kernel function using the derivatives calculated based on the reference image signal. The calculated adaptive kernel function is transmitted to the interpolated image creation unit 454.

In the interpolated image creation unit 454, each color signal component is interpolated using the reference image signal generated based on the regular Gaussian interpolation method and using the adaptive kernel function based on the reference image signal.

In Embodiment 6 as well, according to the image processing system with the above structure, a reference image is created, derivatives are calculated based on the reference image, and an interpolated image signal can be created based on the reference image and the derivatives, i.e. gradient information. As a result, an interpolated image signal with reduced occurrence of false colors can be generated from an original image signal formed from multiband color signal components.

Note that since the reference image is created with a Gaussian interpolation method without using an adaptive kernel function, as in Embodiment 5, the effect of suppressing the occurrence of false colors is achieved to a lesser degree than with Embodiment 1. Since the interpolated image is created using an adaptive kernel function, however, the occurrence of false colors can be reduced as compared to creating the interpolated image with well-known linear interpolation.

The present invention has been described based on the drawings and embodiments, yet it should be noted that a person of ordinary skill in the art can easily make a variety of modifications and adjustments based on the present disclosure. Accordingly, these modifications and adjustments should be understood as being included within the scope of the present invention.

For example, in Embodiments 1 through 6, all color signal components themselves are interpolated in the interpolated image creation units 45, 450, 451, 452, 453, and 454, yet alternatively a portion of the color signal components may be generated by interpolation using color differences.

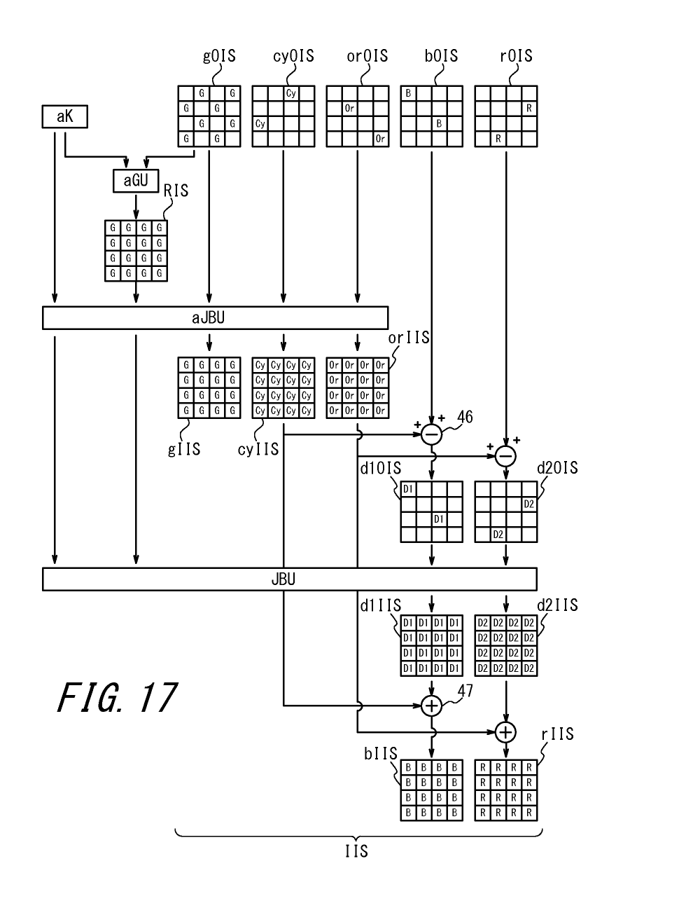

For example, generation of an interpolated image signal using color differences in Embodiment 1 is described. As illustrated in FIG. 17, the G interpolated image signal component gIIS, Cy interpolated image signal component cyIIS, and Or interpolated image signal component orIIS are generated in the same way as Embodiment 1.

From the generated Cy interpolated image signal component cyIIS, the Cy color signal component is extracted for the same pixel as the pixel in which the B original image signal component bOIS exists. Via a subtractor 46, the extracted Cy color signal component is subtracted from the B original image signal component bOIS, so that a first color difference original image signal component d1OIS is generated. Similarly, a second color difference original image signal component d2OIS is generated from the Or interpolated image signal component orIIS and the R original image signal component rOIS.

Using the adaptive kernel function, reference image signal RIS, and first color difference original image signal component d1OIS, the first color difference signal component that has not been generated is interpolated for all pixels with the adaptive joint bilateral interpolation method. A first color difference interpolated image signal component d1IIS is generated by interpolation of the first color difference signal component. Similarly, using the adaptive kernel function, reference image signal RIS, and second color difference original image signal component d2OIS, a second color difference interpolated image signal component d2IIS is generated with the adaptive joint bilateral interpolation method.

Via an adder 47, the Cy interpolated image signal component cyIIS is added to the first color difference interpolated image signal component d1IIS, so that a B interpolated image signal component bIIS is generated. Similarly, the Or interpolated image signal component orIIS is added to the second color difference interpolated image signal component d2IIS, so that an R interpolated image signal component rIIS is generated.

In this way, interpolation can be performed using color differences. By performing interpolation using color differences, a dramatic deterioration in color reproducibility for a pixel can be suppressed even when a large noise component exists in any of the color signal components.

Note that in the above description, interpolation is performed using color differences in a modification to Embodiment 1, yet interpolation can similarly be performed using color differences in Embodiments 2 through 6 as well.

In the above description, the color difference between the Cy color signal component and the B color signal component and the color difference between the Or color signal component and the R color signal component are calculated, and interpolation is performed. As the bands of the colors used in calculating the color difference are closer, the color difference is more useful for enhancing color reproducibility. Calculation of the color difference is not, however, limited to the above combinations. For example, a color difference signal component based on the G interpolated image signal component and the Cy original image signal component may be interpolated.

In Embodiments 1 through 6, the reference image signal is generated using the G original image signal component, yet alternatively after generation of the color signal component for any interpolated image signal, the interpolated image signal thus generated may be used as the reference image signal for interpolation of the other color signal components.

In Embodiments 1 through 6, all color signal components themselves are interpolated using the reference image signal generated based on the G original image signal component, yet the generated G interpolated image signal component, for example, may be used as the reference image signal (secondary reference image) for interpolation of the Cy original image signal component, Or original image signal component, B original image signal component, and R original image signal component.

The reproducibility of the color signal component is generally higher for an interpolated image signal component than for a reference image signal generated based on the G original image signal component. As a result, using the interpolated image signal component as the reference image signal can enhance the reproducibility of the interpolated image.

In Embodiments 1 through 6, the proportion of the G color filters in the CFA21a is the largest, yet the proportion of the color filters of a different band may be the largest.

In Embodiments 1, 2, and 4 through 6, in the (adaptive) joint bilateral interpolation, the weight r(Iₓᵢ−Iₓ) corresponding to the difference between the pixel values of the pixel of interest and the surrounding pixel is used, yet a different weight corresponding to the similarly between the pixel of interest and the surrounding pixel may be used.

In the (adaptive) joint bilateral interpolation method, when optical information for the pixel of interest and the surrounding pixel in the reference image is similar, i.e. the difference between pixel values is close, the magnitude of the weight for the surrounding pixel increases. Accordingly, instead of using such a weight, the same effects as in the above-described embodiments can be achieved by using a larger weight as the similarly increases, as described above.

For example, in the reference image signal, the geometric mean of the difference between the pixel values of a 3×3 region of pixels centering on the pixel of interest and a 3×3 region of pixels centering on a surrounding pixel may be treated as the similarly between the pixel of interest and the surrounding pixel, and weighting may be performed in accordance with the geometric mean.

In Embodiments 1 through 4, the largest proportion of the G color filters is 50%, yet the proportion is not limited to 50%. Since an adaptive Gaussian interpolation method is applied for generation of the reference image signal, a reference image signal with highly accurate color components as compared to a regular Gaussian interpolation method can be generated.

In Embodiments 5 and 6, for each pixel in the CFA21a, the bands of color filters corresponding to two diagonally adjacent pixels are equivalent, yet this arrangement is not required. In Embodiments 5 and 6, an adaptive kernel function is not used for generation of the reference image signal, and therefore the color filter arrangement is not limited to the above-described arrangement.

In Embodiments 1 through 6, five bands of color filters are provided in the CFA21a, yet any number three or greater may be provided.

In Embodiment 2, derivatives based on the original image signal and derivatives based on the reference image signal are calculated by a single derivative calculation unit 420, yet these derivatives may be calculated by separate derivative calculation units.

In Embodiment 6, derivatives in diagonal directions of the pixel of interest are calculated based on the reference image signal, yet derivatives may be calculated in the row and column directions. Since no pixel signals are lacking in the reference image signal, derivatives can be calculated in the row and column directions. Furthermore, in Embodiment 2, when using separate derivative calculation units to calculate derivatives based on the reference image signal as described above, derivatives may be calculated in the row and column directions when calculating derivatives based on the reference image signal.

In Embodiments 1 and 2, the same value is used for the predetermined design parameter h used in calculation of the adaptive kernel function in both the adaptive Gaussian interpolation method and adaptive joint bilateral upsampling, yet different values may be used.

In Embodiments 1 through 6, the reference image signal and the interpolated image signal components corresponding to the colors are generated by interpolating the missing pixel signals in the original image signal components corresponding to the colors, yet a pixel detected as not missing in the original image signal components may be treated as a pixel of interest for interpolation.

In Embodiments 1 through 6, the image processing system is adopted in the digital camera 10, yet the image processing system may be adopted in any device that processes a multiband image signal in which a portion of the color signal components are missing. For example, the image processing system can be adopted in a video camera or an electronic endoscope, and furthermore in an image processing device that processes an image signal received from a recording medium or via a connection cable.

### REFERENCE SIGNS LIST

10: Digital camera
20: Image sensor
21a: Color filter array (CFA)
21u: Color filter repetition unit
30: Image signal processing unit
40, 400, 401, 402, 403, 404: Multiband demosaicing (MB) unit
41, 410, 411, 412, 413, 414: Distribution unit
42, 420, 421, 422, 423, 424: Derivative calculation unit
43, 430, 431, 432, 433, 434: Adaptive kernel calculation unit
44, 440, 441, 442, 443, 444: Reference image creation unit
45, 450, 451, 452, 453, 454: Interpolated image creation unit
46: Subtractor
47: Adder
IIS: Interpolated image signal
bIIS: B interpolated image signal component
cyIIS: Cy interpolated image signal component
d1OIS, d2OIS: First, second color difference original image signal component
gIIS: G interpolated image signal component
orIIS: Or interpolated image signal component
rIIS: R interpolated image signal component
RIS: Reference image signal
OIS: Original image signal
bOIS: B original image signal component
cyOIS: Cy original image signal component
gOIS: G original image signal component
orOIS: Or original image signal component
rOIS: R original image signal component
RIS: Reference image signal

1. An image processing system for interpolating color signal components from an original image signal formed by a plurality of pixel signals each including any of first through m^{th} (m being an integer three or greater) color signal components, so that all of the pixel signals forming the original image signal include the first through m^{th} color signal components, the image processing system comprising:
a reception unit configured to receive the original image signal;
a derivative calculation unit configured to calculate a derivative for the pixel signals using two pixels of a same color sandwiching a pixel corresponding to the pixel signals;
a reference image creation unit configured to create a primary reference image using the first color signal component in the original image signal; and
an interpolated image creation unit configured to create an interpolated image by interpolating all of the color signal components using the primary reference image, wherein
at least one of the primary reference image and the interpolated image is created using the derivative.

2. The image processing system according to claim 1, wherein a number of elements of the first color signal component is largest within the plurality of pixel signals forming the original image signal, only the interpolated image is created using the derivative, and the reference image creation unit, by interpolating the first color signal component, creates a primary reference image signal formed by all of the pixel signals having only the first color signal component.

3. The image processing system according to claim 1, wherein
the derivative calculation unit calculates the derivative as a derivative A for each pixel using the original image signal, and
by interpolating the first color signal component using the derivative A, the reference image creation unit creates a primary reference image signal formed by all of the pixel signals having only the first color signal component

4. The image processing system according to claim 3, wherein the reference image creation unit interpolates the first color signal component using the derivative A with an adaptive Gaussian interpolation method.

5. The image processing system according to claim 3, wherein only the primary reference image is created using the derivative A.

6. The image processing system according to claim 5, wherein the interpolated image creation unit interpolates all of the color signal components with a guided filter.

7. The image processing system according to claim 5, wherein the interpolated image creation unit interpolates all of the color signal components with joint bilateral interpolation.

8. The image processing system according to claim 1, wherein
the derivative calculation unit calculates the derivative as a derivative B for each pixel using the original image signal, and
the interpolated image creation unit creates the interpolated image using the primary reference image and the derivative B.

9. The image processing system according to claim 3, wherein the interpolated image creation unit creates the interpolated image using the primary reference image and the derivative A.

10. The image processing system according to claim 1, wherein
the derivative calculation unit calculates the derivative as a derivative C for each pixel using the primary reference image, and
the interpolated image creation unit creates the interpolated image using the primary reference image and the derivative C.

11. The image processing system according to claim 8, wherein the interpolated image creation unit interpolates all of the color signal components with adaptive joint bilateral interpolation.

12. The image processing system according to claim 11, wherein weighting based on a difference in signal strength of the pixel signals between pixels, or weighting based on similarity of surroundings of a plurality of the pixels used in calculation, is used for the adaptive joint bilateral interpolation.

13. The image processing system according to claim 1, wherein
the interpolated image creation unit
interpolates the second color signal component using the primary reference image,
calculates a color difference between (i) the second color signal component corresponding to the pixel signal having the third color signal component and (ii) the third color signal component,
interpolates the color difference using the primary reference image, and
creates the third color signal component corresponding to all of the pixel signals based on the interpolated color difference and on the interpolated second color signal component.

14. The image processing system according to claim 1, wherein
the interpolated image creation unit
interpolates any of the first through m^{th} color signal components using the primary reference image, and
treats an image formed by the color signal components that have been interpolated as a secondary reference image and uses the secondary reference image to interpolate a color signal component that has not been interpolated.

15. The image processing system according to claim 10, wherein the interpolated image creation unit interpolates all of the color signal components with adaptive joint bilateral interpolation.

16. The image processing system according to claim 15, wherein weighting based on a difference in signal strength of the pixel signals between pixels, or weighting based on similarity of surroundings of a plurality of the pixels used in calculation, is used for the adaptive joint bilateral interpolation.
